(19) United States
(12) Patent Application Publication
(10) Pub. No.: US 2009/0259730 A1
(43) Pub. Date: Oct. 15, 2009

(54) CONTENT ACCUMULATING SYSTEM, USER TERMINAL APPARATUS, CONTENT ACCUMULATING METHOD,CONTENT ACCUMULATING PROGRAM AND STORAGE MEDIUM

(75) Inventors: Satoshi Machida, Tokyo (JP); Atsunori Isozumi, Tokyo (JP)

Correspondence Address: YOUNG & THOMPSON, 209 Madison Street, Suite 500, ALEXANDRIA, VA, 22314, US

(73) Assignee: NEC PERSONAL PRODUCTS, LTD., Tokyo (JP)

(21) Appl. No.: 12/067,295

(22) PCT Filed: Sep. 25, 2006
(86) PCT No.: PCT/JP2006/318999

§ 371 Date: Mar. 19, 2008

(30) Foreign Application Priority Data
Sep. 26, 2005 (JP) 2005-278269

(51) Int. Cl. G06F 15/16

(52) U.S. Cl. 709/219; 709/232; 709/203

(57) ABSTRACT

A content storing system for allowing a storing apparatus, which has a limited size of storage capacity, to be effectively used to record content data. The content storing system includes a user terminal apparatus that records content data received from an external apparatus; and a server that is connected to the user terminal apparatus and that records the content data received from the external apparatus. The user terminal apparatus notifies the server that the content data has been recorded, and further issues, to the server, a delivery request for the content data that was recorded in a user storage apparatus. In response to the delivery request, the server determines, from the notification, that the content data has been recorded, and then the server transmits the requested content data to the user terminal apparatus.

### TECHNICAL FIELD

The present invention relates to a content accumulating system, a user terminal apparatus used in the system, a content accumulating method, a content accumulating program, and a storage medium for recording the program.

### BACKGROUND ART

In recent years, broadcast programs and video data and music data distributed by streaming distribution through the Internet or the like are viewed and recorded by a user terminal apparatus such as a personal computer, an AV equipment, and a mobile terminal are widely spread. In the user terminal apparatus such as the personal computer, the AV equipment, and the mobile terminal, content data such as the video data and the music data is recorded in a storage device such as a hard disc and a memory.

A data quantity of the content data such as the broadcast program content data, and the video data and music data distributed by the streaming distribution is relatively large. Thus, it is necessary to reserve a storage capacity of the storage device used in the user terminal apparatus. For this reason, unnecessary data is erased or moved to a recording medium such as an optical disc, an optical magnetic disc, a memory card, and a hard disc in many cases. After the content data is moved from the storage device of the user terminal apparatus to a recording medium, the content data in the storage device is erased. Thus, there is a case that a failure of the movement causes the content data to be erased from both of the storage device of the user terminal apparatus and the recording medium. Also, since a storage data is overwritten with other data, there is a case that the necessary content data is lost.

A related art cannot recover, correct or acquire the content data having erased from the storage device again. Thus, the erased content data could not be viewed (or acquired) again.

As one of the related arts, Japanese Patent Application Publication (JP-P2005-175884A) describes a mobile type broadcast receiving apparatus in which a user can record a broadcasting program without being conscious of an empty capacity of a recording medium. When detecting that the empty capacity of the recording medium to which the acquired program content is written is zero, the mobile type broadcast receiving apparatus described in Japanese Patent Application Publication (JP-P2005-175884A) distributes a received content to a server apparatus and reserves an empty capacity in the recording medium.

In this way, a technique described in Japanese Patent Application Publication (JP-P2005-175884A) can record the content in a recording medium and a server apparatus in the mobile type broadcast receiving apparatus without any loss of the recorded content, while dividing the content. However, Japanese Patent Application Publication (JP-P2005-175884A) does not disclose a technique that can again acquire and reproduce the erased content data, when the recorded content data having written to the recording medium is erased.

Also, Japanese Patent Application Publication (JP-P2005-242774A) describes a recording system in which, even if a storage capacity of a recording medium is lack when the content is recorded, the entire of target content can be normally recorded, and the erasure of the content having recorded in the recording medium is not caused.

A recording system described in Japanese Patent Application Publication (JP-P2005-242774A) is a system that contains a recording apparatus and a server apparatus, which are connected to each other through a network. The recording apparatus transmits the recorded content, which has been recorded in the recording medium, to the server apparatus, if a remaining capacity of the recording medium is little when the content should be recorded in the recording medium. At this time, the recorded content transmitted to the server apparatus is erased from the recording medium. Also, the recording apparatus contains a managing unit for managing a management data of the contents having recorded in the recording medium, and a management data of the contents transmitted to the server apparatus. The server apparatus records the content received from the recording apparatus in a recording medium of the server apparatus. However, Japanese Patent Application Publication (JP-P2005-24277A) does not disclose a technique that when the recorded content having written to the recording medium of the recording apparatus is erased, the erased content data can be again acquired and reproduced.

Moreover, Japanese Patent Application Publication (JP-P2002-055856A) describes a receiving terminal apparatus that receives a broadcasted content, accumulates it in a recording medium and provides the content having accumulated in the recording medium to a user.

A receiving terminal apparatus described in Japanese Patent Application Publication (JP-P2002-055856A) sequentially receives a plurality of broadcasted contents, accumulates them in a recording medium, determines whether or not the content specified by a user can be transferred from the recording medium to a device used by the user, and transfers the content from the recording medium to the device if it can be transferred. However, in Japanese Patent Application Publication (JP-P2002-055856A), a technique is not disclosed that when the content transferred to the device is erased, the erased content data can be again acquired and reproduced.

### DISCLOSURE OF INVENTION

An object of the present invention is to provide a content accumulating system in which content data can be recorded by efficiently using a storage device having a limitation in a storage capacity, a user terminal apparatus used in the system, a content accumulating method, a content accumulating program, and a recording medium for recording its program.

Another object of the present invention is to provide a content accumulating system in which an erased content data can be recovered among content data having been recorded in a user terminal apparatus, a user terminal apparatus used in the system, a content accumulating method, a content accumulating program, and a recording medium for recording its program.

The content accumulating system according to the present invention includes at least one user terminal apparatus and a server connected to the user terminal apparatus. The user terminal apparatus and the server are desirably connected through the network. The user terminal apparatus includes a user content recorded section in which a content data transmitted from an external unit is recorded; a user recorded data notifying unit for notifying that the content data has been recorded in the user content recorded section to the server; and a content requesting section for issuing a distribution request of the content data recorded in the user content recorded section to the server.

The server includes a recorded data confirming section for confirming whether or not the content data to be distributed has been recorded in the user terminal apparatus, in accordance with a notice from the user terminal apparatus; and a content distributing section for distributing the content data confirmed to have been recorded, to the user terminal apparatus. The user terminal apparatus acquires the content data confirmed to have been [Recorded] by the server and records in the user content recorded section or outputs to a display unit.

In this way, since the user terminal apparatus notifies a record state of the content data to the server, the server can manage what content data has been recorded in the user terminal. Also, only when the content data having been recorded in the user terminal apparatus is requested, the requested content data can be distributed to the server.

The user record data notifying section transmits a content indication data to the server to identify the content data having been recorded in the user content recorded section, and the server manages In order to management a record state of the content data in the user terminal apparatus, it is desirable that the server includes a user recorded content managing section for recording the record state of the content data in the user terminal apparatus as [Recorded] in the server recorded content management table in accordance with a server recorded content management table and the content indication data transmitted from the user terminal apparatus. The recorded data confirming section refers to the server recorded content management table to check whether or not the content data to be distributed has been recorded in the user terminal apparatus. In this way, the server can update the server recorded content management table in accordance with the content indication data transmitted from the user terminal apparatus and manage the record state of the user terminal apparatus.

According to the user terminal apparatus, the content accumulating system, the content accumulating method based on the present invention and a recording medium for recording a program, the user terminal apparatus can efficiently use the storage device having a limitation on a storage capacity and record the content data.

Also, it is possible to recover the erased content data, among the content data having been recorded in the user terminal apparatus.

### BRIEF DESCRIPTION OF DRAWINGS

FIG. 1 is a block diagram showing a configuration of a content data accumulating system according to a first exemplary embodiment of the present invention;

FIG. 2 is a configuration view in an exemplary embodiment of a user terminal apparatus according to the present invention;

FIG. 3 is a configuration view in an exemplary embodiment of a user recording section according to the present invention;

FIG. 4 is a configuration view in an exemplary embodiment of a user content recording unit according to the present invention;

FIG. 5 is a configuration view in an exemplary embodiment of a user recorded content management table according to the present invention;

FIG. 6 is a configuration view in an exemplary embodiment of a user terminal control program according to the present invention;

FIG. 7 is a configuration view in an exemplary embodiment of a server according to the present invention;

FIG. 8 is a configuration view in an exemplary embodiment of a server recording unit according to the present invention;

FIG. 9 is a configuration view in an exemplary embodiment of a server content recording unit according to the present invention;

FIG. 10 is a configuration view in an exemplary embodiment of a server recorded content management table according to the present invention;

FIG. 11 is a configuration view in an exemplary embodiment of a server control program according to the present invention;

FIG. 12A is one example of a configuration in a first exemplary embodiment of the server recorded content management table according to the present invention;

FIG. 12B is one example of a configuration in a third exemplary embodiment of the server recorded content management table according to the present invention;

FIG. 13 is an operation flow of a re-obtaining process for a recorded program content data in a first exemplary embodiment of the content data accumulating system according to the present invention;

FIG. 14 is an operation flow of a re-obtaining process for a recorded program content data in a second exemplary embodiment of the content data accumulating system according to the present invention;

FIG. 15 is an operation flow of a re-obtaining process for a recorded program content data in a third exemplary embodiment of the content data accumulating system according to the present invention;

FIG. 16 is a view showing a system configuration example of a fourth exemplary embodiment;

FIG. 17 is an explanation view of a management table in the fourth exemplary embodiment;

FIG. 18 is a configuration view of a content data in a fifth exemplary embodiment;

FIG. 19 is a configuration view of a server content recording unit in the fifth exemplary embodiment;

FIG. 20 is a configuration view of a feature amount table in the fifth exemplary embodiment;

FIG. 21 is a flowchart explaining an upload of the perfectly same content data; and

FIG. 22 is a flowchart explaining an upload of content data whose record times are different.

### BEST MODE FOR CARRYING OUT THE INVENTION

Hereinafter, a content accumulating system according to exemplary embodiments of the present invention will be described in detail with reference to the attached drawings. The content accumulating system in the exemplary embodiments for accumulating a program content data broadcasted by a broadcast station or the like as the content data will be described below. In the following description, same reference numerals and symbols are assigned to same components, and when there are a plurality of corresponding portions, additional numbers are added after the reference numerals and symbols.

### (Configuration)

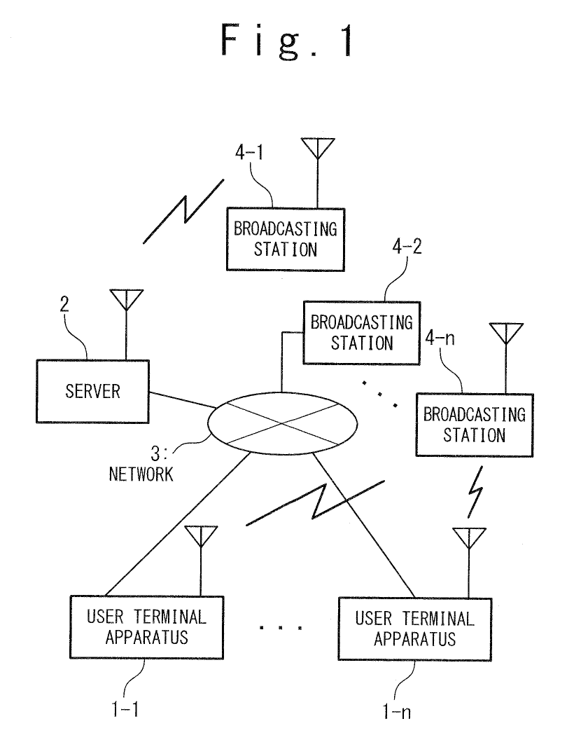

The configuration of the content accumulating system in an exemplary embodiment will be described below with reference to FIG. 1 to FIG. 11.

FIG. 1 is a block diagram showing the configuration of the content accumulating system according to the exemplary embodiment of the present invention. The content accumulating system according to the present exemplary embodiment contains a plurality of user terminal apparatuses 1-1 to 1-n and a server 2, both of which are connected through a network 3. The user terminal apparatus 1 or the server 2 receives and records as a content data, a program content data which is broadcast from either of a plurality of external apparatuses, for example, either of broadcast stations 4-1 to 4-n through wired lines or wireless lines. The user terminal apparatus 1 notifies a data of programs having been recorded to the server 2, and the server 2 recognizes record states of the user terminal apparatuses 1-1 to 1-n based on the notices. When receiving a distribution request to the recorded program from the user terminal apparatus 1, the server 2 refers to the record states of the user terminal apparatuses 1 in response to the distribution request to transmit the program content data.

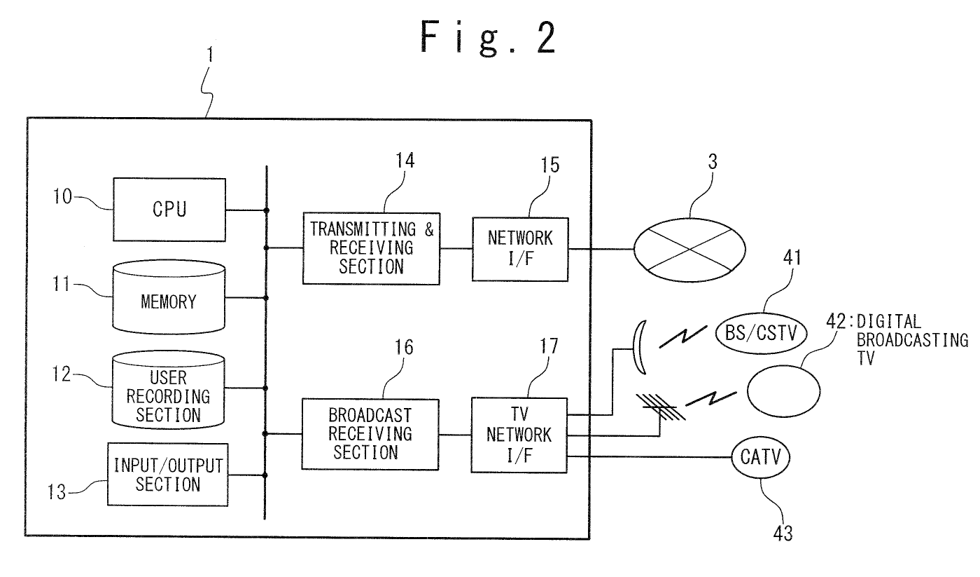

The user terminal apparatus 1 according to the present invention is a recorder that can receive and record a broadcast program, such as a hard disc recorder, a mobile telephone with a television function, and a personal computer with a television function. As shown in FIG. 2, the user terminal apparatus 1 contains a CPU 10 that executes a user terminal control program 100 in a user recording section 12 to control the user terminal apparatus 1, a memory 11 serving as a main storage device such as RAM, for temporarily storing the user terminal control program 100 and various data when the CPU 10 carries out processes, the user recording section 12 serving as an external storage device such as a hard disc and a memory, an input/output section 13 that has an input unit such as buttons, a touch panel, and a keyboard and a display device such as a display, a transmitting & receiving section 14 including a transmitting & receiving circuit that is connected through the network 3 to the server 2 and transmits and receives data, and a broadcast receiving section 16 for receiving a content data of a broadcast program for each channel received from the broadcast stations 4 and displaying on the display device (not shown) or recording on the user recording section 12. Here, the transmitting & receiving section 14 is connected through a network interface (network I/F) 15 to the network 3 such as the Internet and LAN (Local Area Network). Also, the broadcast receiving section 16 receives any or all of a satellite television program (BS/CSTV) 41, ground wave digital and analog television programs (ground wave TV) 42 and a cable television program (CATV) 42 that are broadcasted from the broadcast stations, through a TV network interface (TV network I/F) 17.

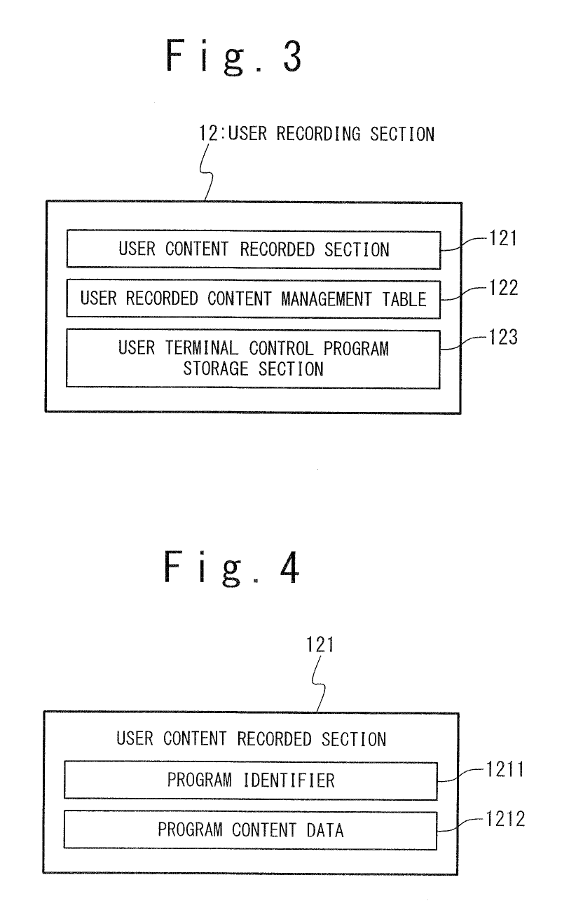

As shown in FIG. 3, the user recording section 12 according to the exemplary embodiment of the present invention contains a user content recorded section 121 as a storage section in which a program content data received by the broadcast receiving section 16 is recorded (video data are recorded including sound data), a user recorded content management table 122 to manage the program content data recorded in the user content recorded section 121, and a user terminal control program storage section 123 for storing the user terminal control program 100 to control the user terminal apparatus 1.

As shown in FIG. 4, a program content data 1212 of a program recorded in the user terminal apparatus 1 and a program identifier 1211 to identify the program are recorded as a pair in the user content recorded section 121. For the program identifier 1211, for example, a program identifier used in EPG (Electronic Program Guide) can be used.

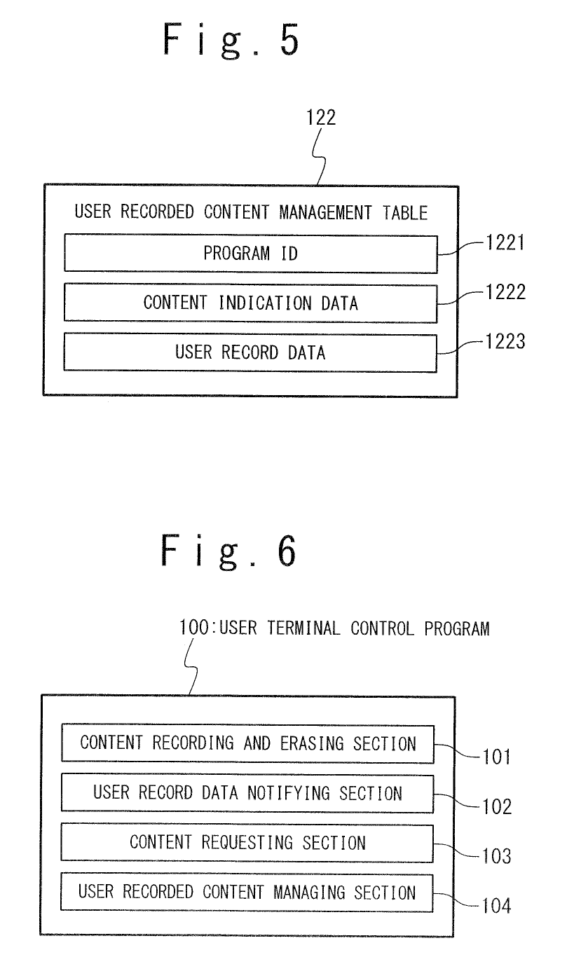

The user recorded content management table 122 is a table to manage a record state of program content data recorded by the user. As shown in FIG. 5, in the user recorded content management table 122 are recorded a program identifier 1221 corresponding to the program identifier 1211 recorded in the user recording section, a content indication data 1222 indicating the contents of the program, and a user record data 1223 indicating various setting conditions in the record. The program identifier 1221 may be a program identifier used in the EPG, and the content indication data 1222 includes data such as a program name, a broadcast station name (usage channel), and a broadcast date and time. Also, the user record data 1223 includes a quality data of the recorded program content data, for example, a video quality data and a sound quality data such as a resolution, a recording method, and a bit rate.

The user terminal control program 100 is a program that is executed by the CPU 10 so as to control various sections of the user terminal apparatus 1. As shown in FIG. 6, the user terminal control program 100 contains a content recording & erasing section 101 for recording the received program content data in the user content recorded section 121 or erasing the program content data having been recorded in the user content recorded section, a user record data notifying section 102 for controlling the transmitting & receiving section 14 and notifying a history data on recorded programs to the server 2, a content requesting section 103 for issuing a distribution request of a desirable program content data to the server 2, and a user recorded content managing section 104 for recording the history data on programs recorded in the user content recorded section 121 in the user recorded content management table 122.

The user terminal apparatus 1 records program content data broadcasted by the broadcast stations 4-1 to 4-n by means of such configurations, and records the history data on recorded programs (the record state of the programs) in the user recorded content management table 122. Also, since the history data is notified to the server 2, the history data on the recorded programs can be shared with the server 2.

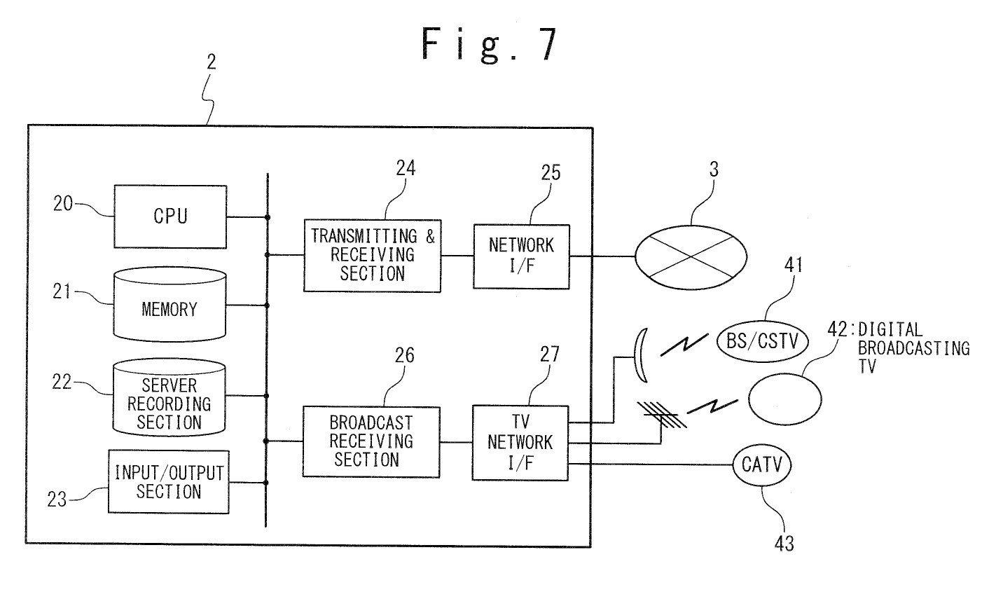

The server 2 according to the present invention is a computer apparatus containing a storage device such as a large capacity of a hard disc, which can receive and record the broadcast program content data. As shown in FIG. 7, the server 2 contains a CPU 20 that executes a server control program 200 stored in a server recording section 22 to control the server 2, a memory 21 serving as a main storage device such as RAM for temporarily storing the server control program 200 and various data when the CPU 20 carries out processes, the server recording section 22 serving as an external storage device such as a hard disc and a memory, an input/output section 23 that has an input unit such as buttons, a touch panel, and a keyboard and a display unit such as a display, a transmitting & receiving section 24 including a transmitting/receiving circuit that is connected through the network 3 to the user terminal apparatuses 1-1 to 1-n and transmits and receives data, and a broadcast receiving section 26 for receiving program content data for each channel from the broadcast stations 4-1 to 4-n and recording it in the server recording section 22. Here, the transmitting & receiving section 24 is connected through a network interface (network I/F) 25 to the network 3 such as the Internet and LAN (Local Area Network) Also, the broadcast receiving section 26 receives any or all of a satellite television program (BS/CSTV) 41, ground wave digital and analog television programs (ground wave TV) 42 and a cable television program (CATV) 42 that are broadcasted from the broadcast stations, through a TV network interface (TV network I/F) 27.

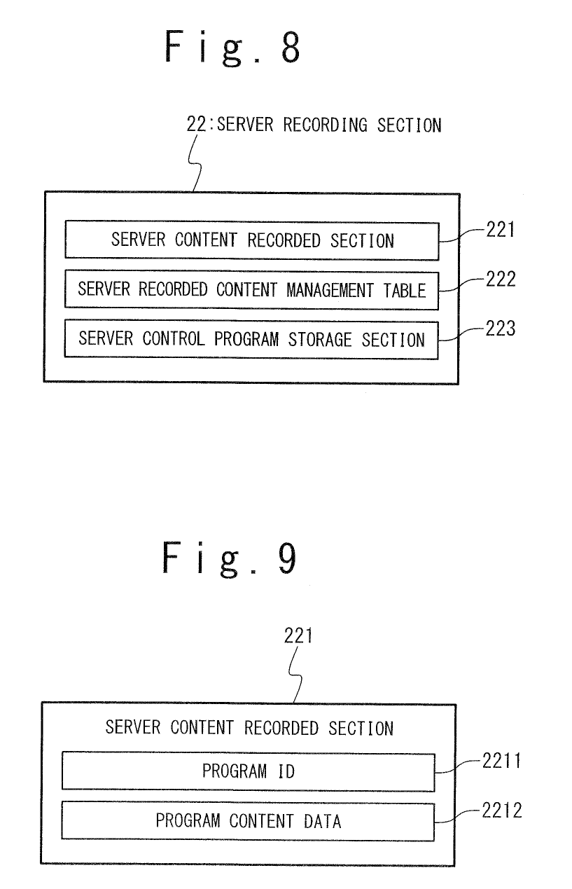

As shown in FIG. 8, the server recording section 22 according to the present invention contains a server content recorded section 221 as a storage section in which a data received by the broadcast receiving section 26 is recorded, a server recorded content management table 222 for managing the program content data recorded in the server content recorded section 221, and a server control program storage section 223 for storing a server control program 200 to control the server 2.

As shown in FIG. 9, a program content data 2212 of a program recorded by the server 2 and a program identifier 2211 to identify the program are stored in the server content recorded section 221. For the program identifier 2211, for example, a program identifier used in the EPG (Electronic Program Guide) may be used.

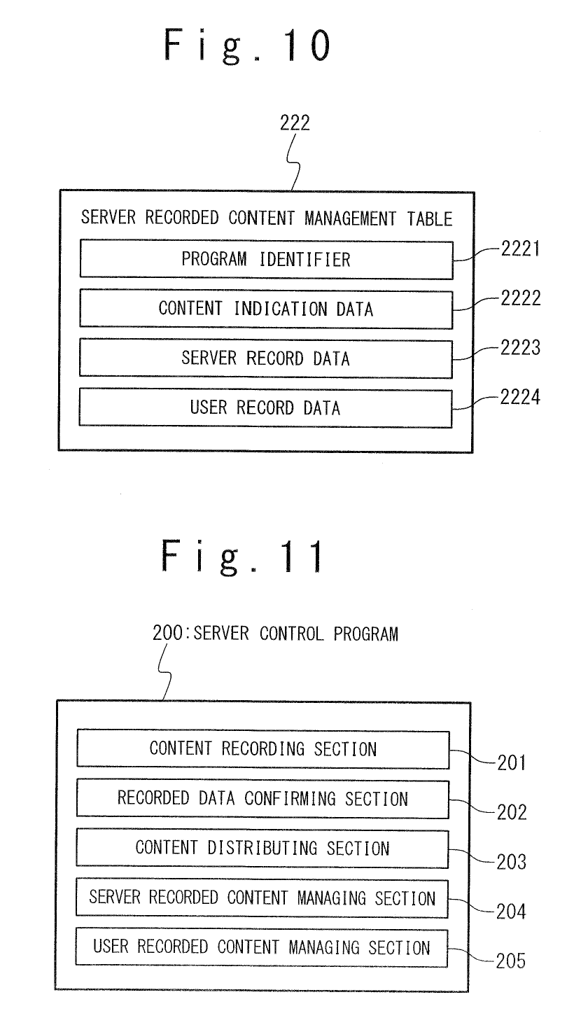

The server recorded content management table 222 is a table to manage a history data on programs recorded by the server 2 and the user terminal apparatuses 1-1 to 1-n. As shown in FIG. 10, in the server recorded content management table 222 are recorded a program identifier 2221 of the program for the program content data recorded in the server content recorded section 221, a content indication data 2222 indicating contents of the program, a server record data 2223 indicating various setting conditions in the record by the server 2, and a user record data 2224 including a record flag indicating whether or not the program content data has been recorded. The content indication data 2222 includes data such as a program name, a broadcast station name (use channel), broadcast date and time. The server record data 2223 includes a quality data when a video data is recorded by the server 2, for example, a video quality data and a sound quality data such as a resolution, a recording method, and a bit rate. A record flag indicating whether or not the program content data has been recorded in the user terminal apparatus 1 and a quality data of the program content data recorded in the user terminal apparatus 1 are recorded for every user identifier in the user record data 2224. Here, as the quality data, the video quality data and sound quality data such as a resolution of the program content data recorded in the user terminal apparatus 1, a recording method, and a bit rate are recorded based on the history data transmitted from the user terminal apparatus 1.

The server control program 200 is a program that is executed by the CPU 20 to control various sections in the server 2. As shown in FIG. 11, the server control program 200 contains a content recording section 201 for recording the received program content data in the server content recorded section 221, a recorded data confirming section 202 that checks whether or not the user terminal apparatus 1 has records the program content data, in response to the distribution request of a program content data issued by the user terminal apparatus 1, a content distributing section 203 for controlling the transmitting & receiving section 24 to transmit the requested program content data to the user terminal apparatus 1, a server recorded content managing section 204 for recording a history data on the recorded program content data in the server recorded content management table 222, and a user recorded content managing section 205 for updating the user record data 2224 in accordance with the history data on the recorded program content data. The history data is notified from the user terminal apparatus 1.

With the above configuration, the server 2 according to the present invention can acquire the history data from the user terminal apparatus 1 on the recorded program content data, and record and manage as the server recorded content management table 222. Also, the server 2 can refer to the server recorded content management table 222 to recognize a record state for each user terminal apparatus 1 and transmits the desired program content data to the user terminal apparatus 1 as a request source in response to the distribution request of the program content data issued from the user terminal apparatus 1.

### First Exemplary Embodiment

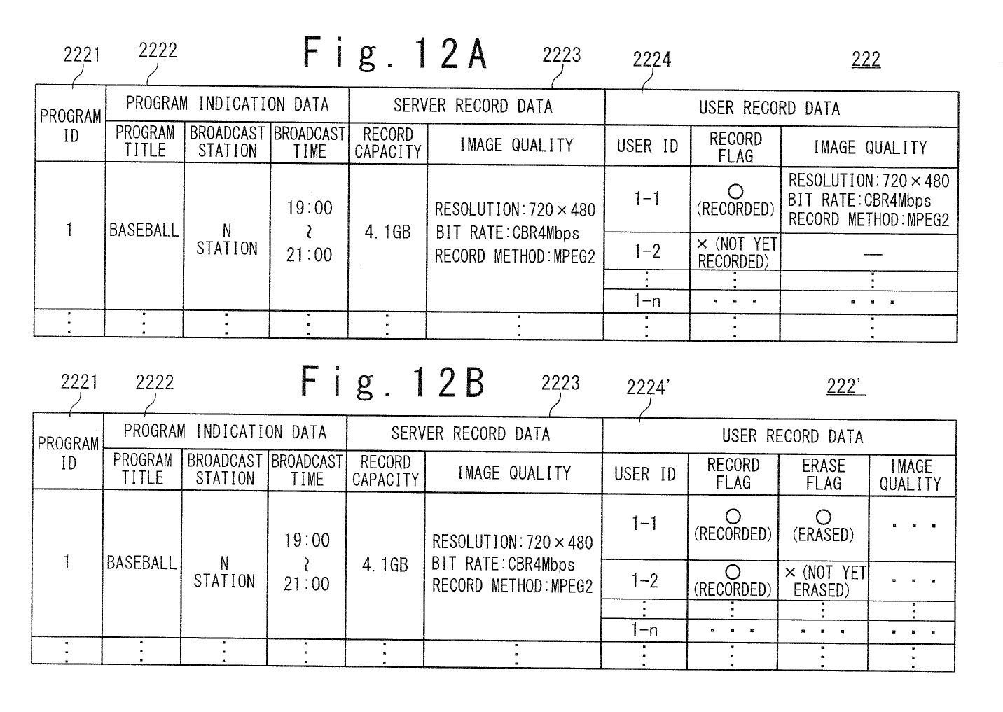

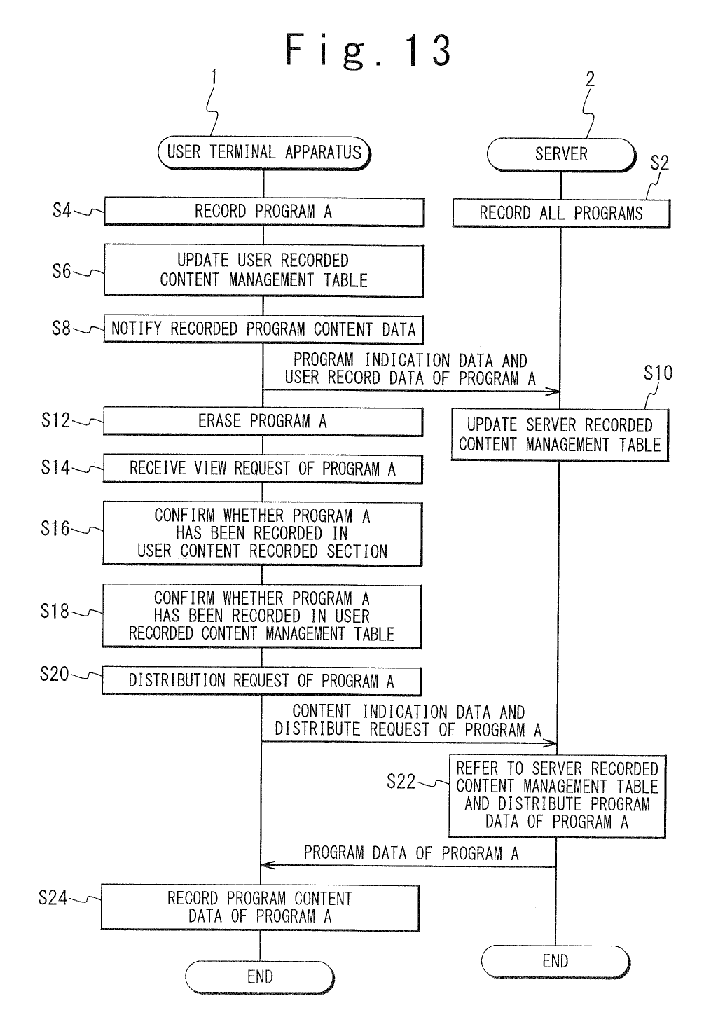

The server 2 in a first exemplary embodiment manages the record state of each of the user terminal apparatuses 1-1 to 1-n, checks whether or not the requested program content data has been recorded by the user terminal apparatus 1 as a request source, in response to the distribution request issued by the user terminal apparatus 1, and distributes the requested program content data to the user terminal 1 if it is determined to have been recorded. With reference to FIG. 12A and FIG. 13, the detail of the operation of a re-acquiring process for the program content data in the content accumulating system according to the first exemplary embodiment of the present invention will be described below. Here, a case that the user terminal apparatus 1 records a live baseball program (hereinafter, to be referred to as a program A) broadcasted between 19.00 and 21.00 by an N-station is used as one example, and an acquiring process for the program content data will be described.

The content recording section 201 in the server 2 according to the present invention records all of program content data broadcasted from all channels in the highest quality of the system, in the server content recorded section 221 (Step S2). At this time, the server recorded content managing section 204 relates the program identifier 2221, a content indication data 2222 including a program name, and a server record data 2223 including a quality data such as a video quality data and a sound quality data of the recorded data, which are received together with the program content data by the broadcast receiving section 26, and sequentially records these data in the server recorded content management table 222, as shown in FIG. 12A.

The user operates the input/output section 13 of the user terminal apparatus 1 and records the program A (Step S4). In this case, the record quality set when the program content data is recorded includes the resolution of 720×480, the bit rate of CBR 4 MbpS, and the recording method of MPEG2. In accordance with a record instruction from the input/output section 13, the content recording & erasing section 101 records the program content data 1212 received by the broadcast receiving section 16, in the user content recorded section 121 in the set record quality. At this time, the program content data 1212 is recorded after the program identifier 1211 (Exemplification: Program Identifier in EPG) is given. It should be noted that the recording process executed by the content recording & erasing section 101 may be directly executed through the operation of the input/output section 13 that is carried out by the user, or may be executed (automatically at the appointed time) in accordance with a reservation data inputted to the input/output section 13.

When a new program content data 1212 is recorded in the user content recorded section 121, the user recorded content managing section 104 records the program identifier 1211 corresponding to the program content data 1212 as the program identifier 1221 (for example, a program identifier [1]) in the user record data 1223, and records the content indication data 1222 indicating the content of the program content data of the program A (for example, the program name [Live Baseball program], the broadcast station name [N-Station] and the broadcast time [19.00 to 21.00]), and the user record data 1223 (the resolution [720×480], the bit rate [CBR, 4 MbpS] and the recording manner [MPEG2]) in the user recorded content management table 122 in relation to the program identifier 1221 (Step S6). At the step S6, when the user recorded content management table 122 is updated, the user record data notifying section 102 extracts the updated program identifier 1221, content indication data 1222 and user record data 1223 from the user recorded content management table 122, and these data are transmitted from the transmitting & receiving section 14 to the server 2 together with the user identifier [for example, [1-1] (Step S8). It should be noted that the timing when the content indication data 1222 and the user record data 1223 are transmitted to the server 2 is not limited to the time of update (recording). These data may be transmitted at a constant time interval or at a predetermined time.

As shown in FIG. 12A, the user recorded content managing section 205 of the server 2 updates the user record data 2224 corresponding to the transmitted user identifier in accordance with the program identifier 1221, the content indication data 1222 and the user record data 1223 that are transmitted from the user terminal apparatus 1 (Step S10). The user recorded content managing section 205 sets a record flag corresponding to the received user identifier [1-1], among the user record data 2224 for the program corresponding to the program identifier 1221 or the content indication data 1222 transmitted from the user terminal apparatus 1, from a non-recorded state to a recorded state, and in accordance with the transmitted user record data 1223, updates the quality data of the user record data 2224 (for example, the video quality data and sound quality data of the program content data) to [Record Quality] as shown in FIG. 12A Here, the record flag corresponding to the user terminal apparatus 1 that does not transmit any of content indication data 1222 and the like (for example, a user identifier [1-2]) is not updated, and the record flag is remained in the non-recorded state. Here, in order to reserve a record capacity of the server content recorded section 221, it is desirable that the program content data in which the record flags for all of the user terminal apparatuses are remained in the non-recorded state are erased from the server content recorded section 221 after the completion of the broadcast time of the program. At this time, on the basis of the timing of the notice at the step S8, the erasure timing is naturally changed.

As mentioned above, when the program is recorded in the user terminal apparatus 1, the data (the record flag) indicating that the program has been recorded in the user terminal apparatus 1 and the quality data including the video quality data and sound quality data in the user terminal apparatus 1 are recorded in the server 2. That is, the server 2 can record and manage the record state of program content data for every user terminal apparatus 1.

Here, in the user terminal apparatus 1, the program content data of the program A is erased from the user content recorded section 121 through any process (Step S12). After the program content data of the program A is erased, there is a case that the user desires to view the program A again. In this case, the user operates the input/output section 13 of the user terminal apparatus 1 to issue a view request to the content requesting section 103 (Step S14). The content requesting section 103 receives the view request and refers to the user content recorded section 121 to check whether or not there is the program content data of the program A for the view request (Step S16). In case of non-existence in the user content recorded section 121 (in case of the program content data having been erased), the content requesting section 103 refers to the user recorded content management table 122 to check whether or not there is the content indication data 1222 on the program A (Step S18). When the presence or absence of the content indication data is checked at the steps S16 and the step S18, the program identifier is desirably used.

If the content indication data 1222 on the desired program A is recorded in the user recorded content management table 122, the content requesting section 103 recognizes that the program A is a program having been recorded, and issues a distribution request of the program content data of the program A to the server 2 (Step S20). At this time, the user identifier, the program identifier 1221 of the program A and the content indication data 1222 are collectively transmitted to the server 2.

The recorded data confirming section 202 in the server 2 refers to the server recorded content management table 222 in accordance with the distribution request issued by the user terminal apparatus 1, to determine whether or not the user terminal apparatus 1 as the request source previously recorded the program, from the transmitted user identifier and the record flag of the user record data 2224 corresponding to the program identifier 1221 or the content indication data 1222. Here, if the program A is determined to have been recorded in the user terminal apparatus 1 as the request source, the content distributing section 203 extracts the program content data 2212 corresponding to the program identifier of the program A from the server content recorded section 221 and converts the quality of the program content data into a quality equal to or less than the quality data of the user record data 2224 and transmits the program content data with the converted quality to the user terminal apparatus 1 (Step S22).

The user terminal apparatus 1 records the program content data of the program A transmitted from the server 2 in the user content recorded section 121 again (Step S24).

As mentioned above, according to the content accumulating system based on the present invention, even if the program previously recorded in the user terminal apparatus 1 has been erased, the program content data of the previously recorded quality data can be acquired again by transmitting a data indicating that the program content data has been recorded, and a data indicating a record situation such as the quality data to the server 2. Also, at the step S16, after the program content data is confirmed to have been erased from the user content recorded section 121, the distribution request of the program content data is issued to the server 2. Therefore, even if the program content data is acquired from the server 2, the data is never copied illegally. Moreover, the content data distributed from the server 2 to the user terminal apparatus 1 is not the content data itself possessed by the server 2, and this is the content data substantially possessed by the user terminal apparatus 1 (or the data that is inferior in the quality to the content data possessed by the user. Thus, the above operation does not means that the server 2 copies and distributes the program content data. Therefore, it is possible to apply the concept of limiting the number of times of copy such as a copy-once technique. It should be noted that when the prevention of the copying of the program content data is not required, the operation of the step S16 may be omitted.

### Second Exemplary Embodiment

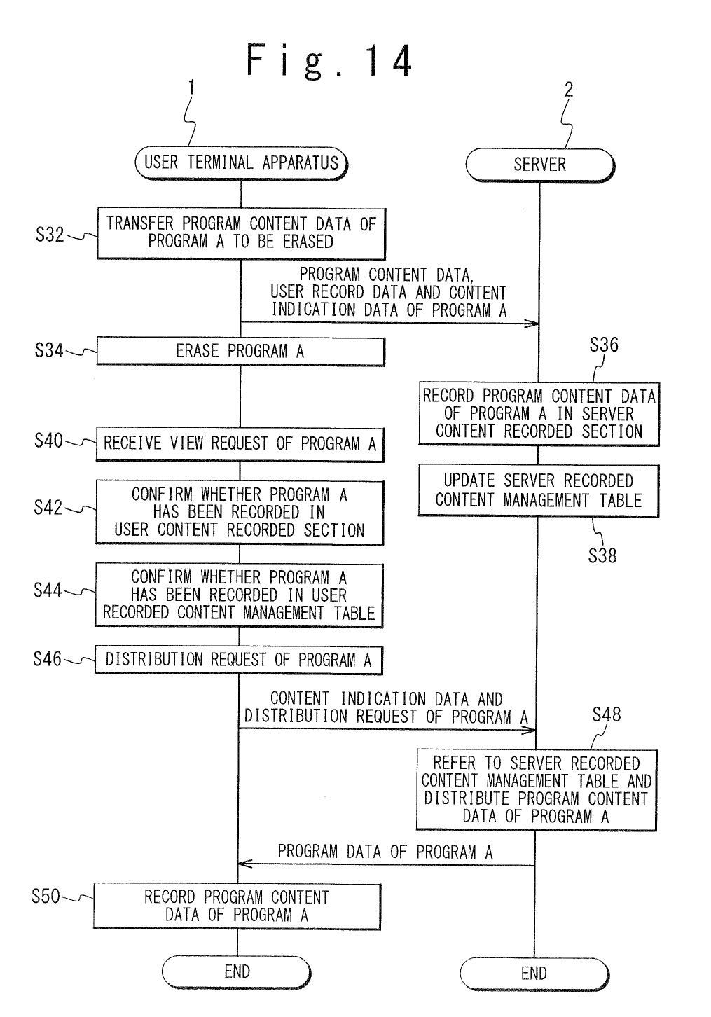

With reference to FIG. 12A and FIG. 14, the operation of the re-acquiring process for the program content data in the second exemplary embodiment of the content accumulation according to the present invention will be described below. The server 2 in the second exemplary embodiment is configured not to have the broadcast receiving section 26 and the TV network I/F 27 in the first exemplary embodiment. In the user terminal apparatus 1 in the second exemplary embodiment, the record history of the content data on the program A recorded in the user content recorded section 121 and the like is recorded in the user recorded content management table 122 through the steps similar to the steps S4 to S8 in the first exemplary embodiment. In the server 2 in the second exemplary embodiment, the program content data of all the channels, all the programs which are broadcasted by the broadcast stations 4-1 to 4-n are not recorded in the server content recorded section 221, but only the program content data of the highest quality among the programs recorded by the user terminal apparatuses 1-1 to 1-n is recorded.

In the user terminal apparatus 1 in the second exemplary embodiment, when the recorded program content data is erased or moved through the operation of the input/output section 13 executed by the user, the user record data notifying section 102 transmits the program content data 1212 of the program A, the user identifier and the program identifier 1221, the content indication data 1222, and the user record data 1223 to the server 2 (Step S32). When the program content data 1212 is transmitted to the server 2, the content recording & erasing section 101 erases the program content data 1212 of the program A and the program identifier 1211 from the user content recorded section 121 (Step S34).

The content recording section 201 in the server 2 records the program content data transmitted from the user terminal apparatus 1 in the server content recorded section 221 (Step S36). At this time, the content recording section 201 refers to the transmitted content indication data, and if the program content data of the same program has been recorded, records the content indication data of a high quality contained in the user record data with a priority. The server recorded content managing section 204 extracts the program identifier 2221, the content indication data 2222 and the server record data 2223 from the content indication data 1222 that is transmitted together with the program content data recorded in the server content recorded section 221, and updates the server record data 2223 in the server recorded content management table 222 (Step S36). Also, the user recorded content managing section 205 updates the user record data 2224 in the server recorded content management table 222 in accordance with the user identifier, the content indication data 1222 and the user record data 1223 which are received from the user terminal apparatus 1, similarly to the first exemplary embodiment (Step S38). In this example, a record flag for the transmitted content indication data or user identifier is set to a recorded state.

When the user tries to view the erased program A again, similarly to the steps from the step S14 to the step S24 in the first exemplary embodiment, the user terminal apparatus 1 can record the program content data of the program A transmitted from the server 2 in the user content recorded section 121 again (Steps S40 to S50).

As mentioned above, in the server 2 according to the second exemplary embodiment, all of the programs are not required to be recorded, and only the erased program in the user terminal apparatus 1 may be recorded. Thus, the unnecessary program content data is not required to be recorded, which makes it possible to reserve a large storage capacity.

Also, in the server 2 in the second exemplary embodiment, even if the program previously recorded in the user terminal apparatus 1 has been erased, the program content data with a quality of the previously recorded data quality can be obtained again by transmitting a record state of a data indicating that it has been recorded, the quality data and the like to the server 2, similarly to the first exemplary embodiment. Also, the server 2 holds only the program content data of the highest quality eased in any of the user terminal apparatuses 1 and distributes as the program content data of a same quality as that of the data possessed by the user terminal apparatus 1. Thus, even if the user terminal apparatus 1 acquires the program content data from the server 2, this does not means the result that the data is copied. Therefore, in the second exemplary embodiment, it is possible to adapt the concept of limiting the number of times of the copy, as in the copy-once technique.

### Third Exemplary Embodiment

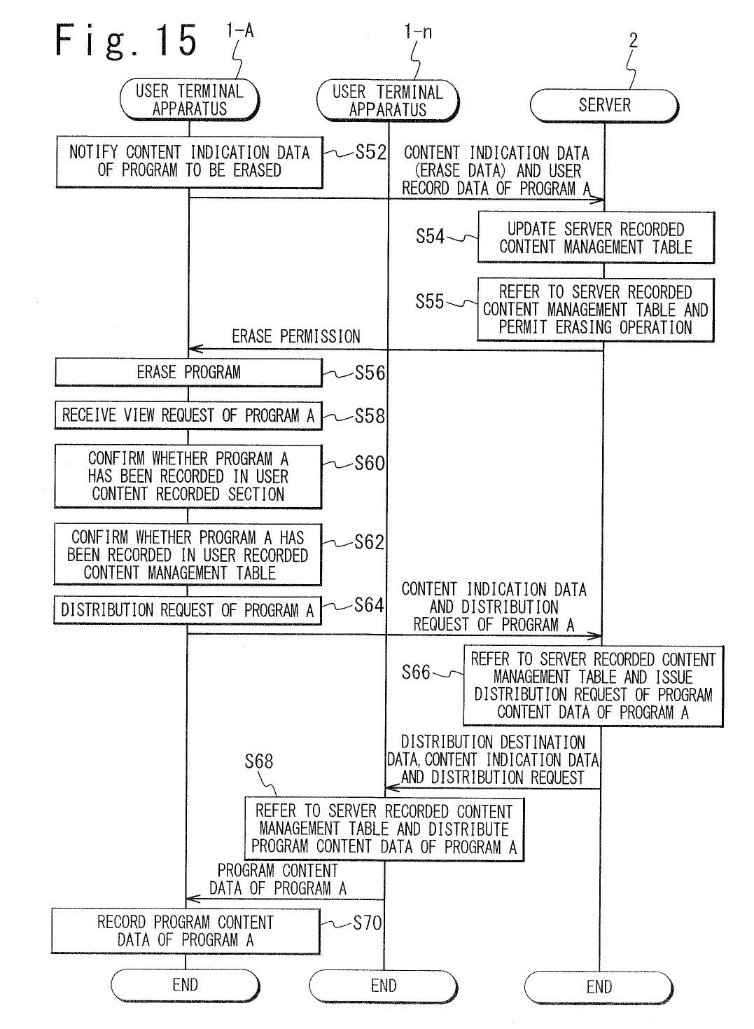

With reference to FIG. 12(b) and FIG. 15, the operation of the re-acquiring process for the program content data in the third exemplary embodiment of the content accumulation according to the present invention will be described below. The server 2 in the third exemplary embodiment is configured not to have the broadcast receiving section 26 and the TV network I/F 27 in the first exemplary embodiment. Also, as shown in FIG. 12, in addition to the data included in the user record data 2224 in the first and second exemplary embodiments, an erasure flag is added to a user record data 2224′ on a server recorded content management table 222′ in the third exemplary embodiment. In the user terminal apparatus 1 in the third exemplary embodiment, similarly to the steps S4 to S10 in the first exemplary embodiment, a record history of the content data on the program A recorded in the user content recorded section 121 or the like is recorded on the user recorded content management table 122 and notified to the server 2. In the server 2, similarly to the step S10 in the first exemplary embodiment, the server recorded content management table 222′ is updated, and a record state of the user terminal apparatus 1 is recognized.

In the third exemplary embodiment, when the user desires the recording program A to be erased or moved, the recording program A is erased or moved through the operation of the input/output section 13 executed by the user. If a predetermined operation is executed by the user, the user record data notifying section 102 transmits the user identifier, the program identifier 1221, the content indication data 1222 and the user record data 1223 to the server 2 (Step S52). At this time, the user record data 1223 contains an erasure desire data indicating that the program A is desired to be erased. The server 2 executes a step similar to the step S10 in the first exemplary embodiment, and updates the server recorded content management table 222′ in accordance with the user identifier, the program identifier 1221, the content indication data 1222 and the user record data 1223 that are transmitted from the user terminal apparatus 1-1 (Step S54). At this time, the erasure flag is set to an erased state in accordance with the erasure desire data contained in the user record data 1223. The recorded data confirming section 202 refers to the user record data 2224′ and if the quality data corresponding to the notified erasure desire data is the highest quality in the content indication data of the program, requests the program content data to the user terminal apparatus 1-1. The user record data notifying section 102 in the user terminal apparatus 1-1 transmits the program content data of the program A to the server 2 in response to the request from the server 2. The content recording & erasing section 101 in the user terminal apparatus 1-1 erases the program content data of the program A moved to the server 2. On the other hand, if the quality data corresponding to the notified erasure desire data is not the highest quality in the content indication data of the program, the recorded data confirming section 202 issues an erasure allowance to the user terminal apparatus 1-1 (Step S55). The content recording & erasing section 101 in the user terminal 1-1 receiving the erasure allowance erases the program A (Step S56). In this way, the server 2 in the third exemplary embodiment can record only the program content data of the highest quality, among the programs erased by the user terminal apparatuses 1-1 to 1-n.

In the third exemplary embodiment, if the user does not desire the recorded program A to be erased or moved, the erasure desire data indicating that the program A is desired to be erased is not notified to the server 2 from the user terminal apparatus 1-n. The user record data notifying section 102 in the user terminal apparatus 1-n transmits the user identifier, the program identifier 1221, the content indication data 1222 and the user record data 1223 to the server 2. The server 2 updates the server recorded content management table 222′ in accordance with the user identifier, the program identifier 1221, the content indication data 1222 and the user record data 1223 that are transmitted from the user terminal apparatus 1-n. At this time, the erasure flag in the user record data 2224′ is set to “non-erased state”.

If the user desires to view the erased program A again, the user operates the input/output section 13 in the user terminal apparatus 1-1. Consequently, similarly to the steps S14 to S20 in the first exemplary embodiment, the distribution request of the program A is issued to the server 2 (Steps S58 to S64).

The recorded data confirming section 202 in the server 2 determines whether or not the user terminal apparatus 1-1 as the request source previously recorded the program, from the record flag of the user record data 2224′ corresponding to the transmitted user identifier and content indication data, by referring to the server recorded content management table 222′ in response to the distribution request issued by the user terminal apparatus 1-1. Also, whether or not the user terminal apparatus 1-1 as the request source has erased the program is checked from the erasure flag. If the program A has been recorded and then erased in the user terminal apparatus 1-1 as the request source, the content distributing section 203 refers to the record flag and the erasure flag that correspond to another user terminal identifier, and searches the user terminal apparatus 1 which has recorded and not erased the program, and then selects a distribution source terminal. For example, if the user terminal apparatus 1-n has a data indicating the recorded state, a data indicating the non-erased state, or an equivalent or lower quality data, the user terminal apparatus 1-n is selected as the distribution source terminal, and the distribution request of the program A is issued to the user terminal apparatus 1-n (Step S66). At this time, the distribution destination data such as an address of the user terminal apparatus 1-1 as the request source of the program content data, and the content indication data are transmitted to the user terminal apparatus 1-n. When the content distributing section 203 selects the distribution source terminal, the quality data of the program content data recorded by the distribution source terminal and the quality data of the program content data recorded by the request source terminal are desirably coincident with each other. Also, at the step S66, when the server 2 issues the distribution request of the program A to the user terminal apparatus 1-n, the user recorded content managing section 205 in the server 2 sets the erasure flag corresponding to the user terminal apparatus 1-1 as the distribution destination to the non-erased state.

The user terminal apparatus 1-n receives the distribution request and extracts the program content data 1212 corresponding to the content indication data of the program A from the user content recorded section 121 and transmits the program content data 1212 to the user terminal apparatus 1-1 in accordance with the distribution destination address (Step S68).

The program content data of the highest quality among the program content data erased in the user terminal apparatus is recorded in the server 2. For this reason, if it is determined at the step S64 that there is not the user terminal apparatus having the quality data equal to or higher than the quality data of the program requested by the distribution destination terminal, the server 2 itself is selected as the distribution source terminal. Then, similarly to the step S22 in the first exemplary embodiment, the program content data of the program A is transmitted to the user terminal apparatus 1-1.

The user terminal apparatus 1-1 records the program content data of the program A transmitted from the user terminal apparatus 1-n or server 2 in the user content recorded section 121 again (Step S70).

### Fourth Exemplary Embodiment

In succession, when the content data is the program content data of a digital broadcast and the user terminal apparatus is a recording unit, the fourth exemplary embodiment will be described in detail. In order to record the digital broadcast, a large quantity of a hard disc (about 10 gigabytes per hour) is required. In the fourth exemplary embodiment, since a recorded file is held in the server on the Internet, it is possible to store a large quantity of the digital broadcast data.

When the file having been recorded by the user is stored on the server, there is a case that the record file of the same program is uploaded by a plurality of users. In the digital broadcast, when the territories and programs are both same, the record files become same. Accordingly, when the same record file is uploaded by the plurality of users, only one file is stored in the server so that the hard disc of the server is effectively used.

Although the record file has been saved on the hard disc in the recording unit, this is encrypted with a different encryption key for every recording unit. Thus, only by comparing the record files, it is difficult to determine whether or not the program recorded by the different recording units is the same program. In order to determine whether or not it is same, the record files are required to be compared after the decryption of the encryption of the recorded data.

When the record file is downloaded from the server to the recording unit, the content on the server is required to be moved. At this time, when the record file is uploaded by the plurality of users, after it is confirmed that all of the users move the record file from the server to the recording units, the record file on the server is required to be erased.

When the record file is uploaded from the recording unit to the server, at first, the recording unit complexes a part or whole of the record file, extracts a feature amount and transmits a broadcast station, a broadcast date, a record time and the feature amount to the server. The server checks whether or not a same record file is located on the server, on the basis of the broadcast station, the broadcast date, the record time and the feature amount. If the same record file is located on the server, the server notifies the fact to the recording unit, and the recording unit does not upload the record file. The server relates the recording unit to the uploaded record file, and registers it, and the recording unit erases the record file. On the other hand, if the same record file is not located on the server, the server notifies the fact to the recording unit, and the recording unit uploads the record file to the server. The server relates the uploaded file to the recording unit and registers it, and the recording unit erases the record file.

When the record file is downloaded from the server, the server checks a relation between the record file requested to be downloaded and the recording unit trying to download and then allows the download only for the recording unit that is related and registered. That is, the download is allowed only for the recording unit that has uploaded the same record file or the recording unit trying to upload the same record file. Prior to the execution of the download, a key is exchanged between the recording unit and the server, and the encrypted record file is downloaded. The relation of the recording unit downloading the record file to the record file is released. At this time, if there is not the other recording unit related to the record file, the server erases the record file.

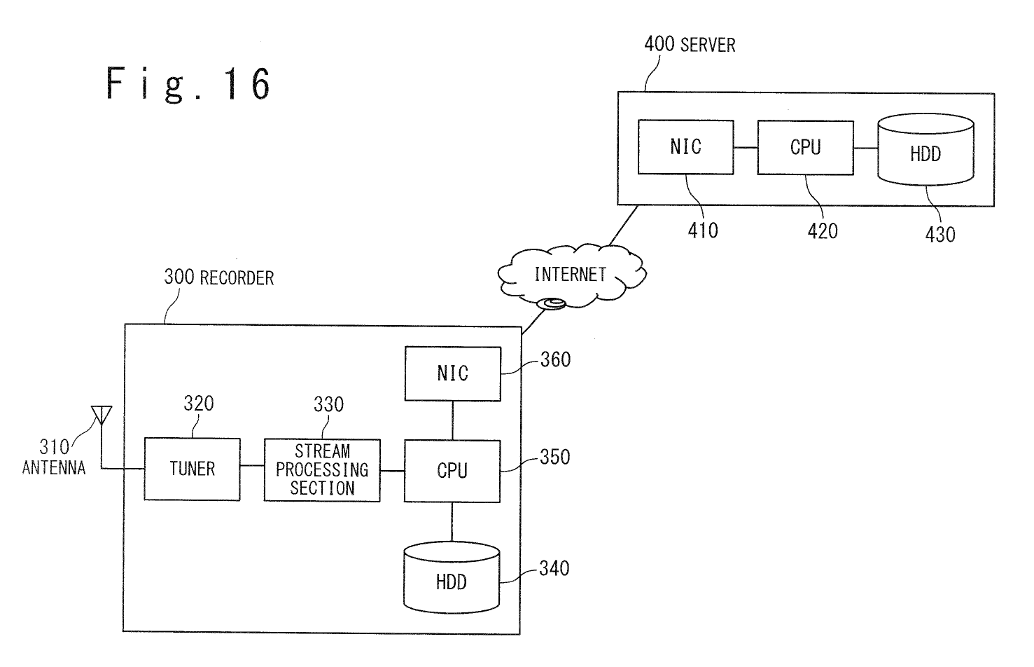

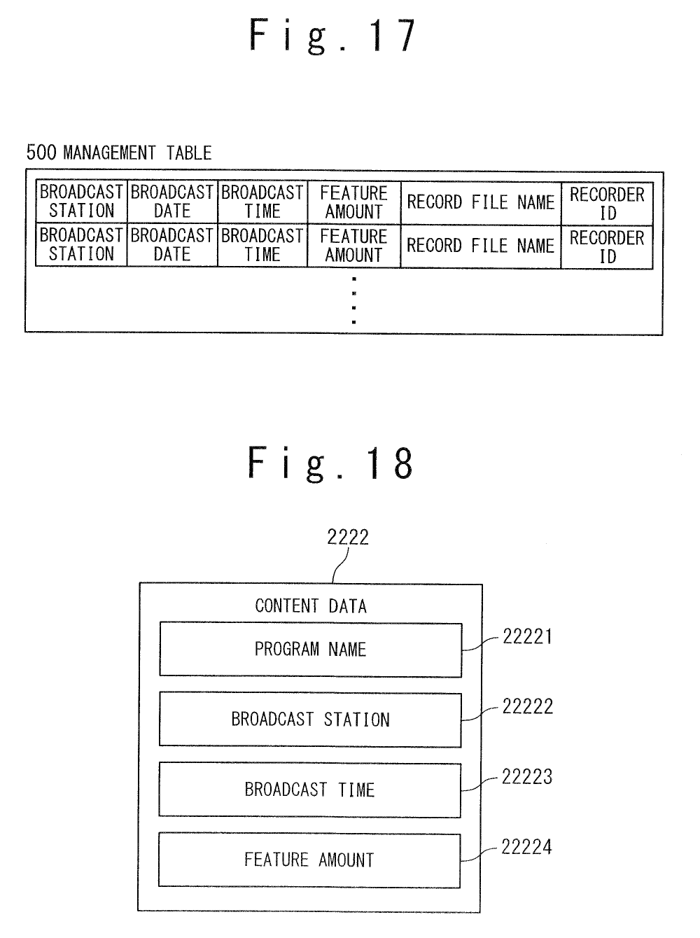

FIG. 16 shows a system configuration example of the fourth exemplary embodiment. In FIG. 16, a recording unit 300 stores a broadcast wave received by an antenna 310 through a tuner 320 and a stream processing section 330 in a hard disc 340. At this time, a CPU 350 encrypts the record file with an encryption key for every recording unit and stores it. The recording unit 300 is connected through a network adaptor (NIC: Network Interface Card) 360 to the Internet. In a server 400, a CPU 420 accumulates the record file uploaded from the recording unit 300 in a hard disc 430. FIG. 17 is an explanation diagram of a management table in the fourth exemplary embodiment. A management table 500 stores the respective data of a broadcast station, a broadcast time, a feature amount, a record file name and a recording unit ID.

When the recording unit 300 uploads the record file to the server 400, the CPU 350 acquires the broadcast station, the broadcast date, and the broadcast time for the record file. Also, the recording unit 300 decrypts a part or whole of the encrypted record files and calculates the feature amount of the record file. The CPU 350 transmits the data of the broadcast station, the broadcast date, the broadcast time and the feature amount to the server 400. In the server 400, the CPU 420 reads the management table 500 stored in the hard disc 430, compares the read data with the data received from the recording unit 300 and checks whether or not the same record file is stored in the hard disc 430. If the same record file exists in the hard disc 430, the recording unit ID of the recording unit 300 trying to upload is registered in the management table 500. If the same record file does not exist in the hard disc 430, the server 400 requests the record file to the recording unit 300, and the recording unit 300 uploads the record file to the server 400. At this time, the server 400 stores the data of the uploaded record file in the management table 500 and registers the recording unit ID in the management table 500. After the uploading process, the recording unit 300 erases the record file of the hard disc 340, as necessary.

When the record file is downloaded from the server 400 to the recording unit 300, the recording unit 300 transmits a downloading request of the record file to the server 400. The server 400 receives the downloading request and reads the management table 500. The server 400 refers to the recording unit ID, which has been related to the record file and registered, in the management table 500. Consequently, it is checked whether or not the recording unit 300 executing the downloading request is related to the record file and registered, by referring to the management table 500. If the recording unit 300 is registered, the key is exchanged between the server 400 and the recording unit 300, and the recording unit 300 downloads the record file. At this time, the server 400 erases the recording unit ID of the recording unit 300 executing the downloading, from the data of the corresponding record file on the management table 500. If the erasure of the recording unit ID results in all the erasures of the recording units ID related to the same record file, the record file is erased from the hard disc 430.

As mentioned above, a server client system having the recording unit as a client has been explained. In addition, a similar system can be attained by using a point-to-point technique and establishing a virtual server between the plurality of recording units connected through the Internet.

### Fifth Exemplary Embodiment

The fifth exemplary embodiment uses the feature amount in determination of whether the content data is different or same. In the fifth exemplary embodiment, as shown in FIG. 18, the content indication data 2222 on the server recorded content management table 222 includes a program name 22221, a broadcast station name 22222, a broadcast time 22223 and a feature amount 22224. The feature amount 22224 is a hash (CRC32, MD5, SHA1 or the like) value of the content data and may be determined from the entire content data or may be determined from a part of the content data. When it is determined from the part of the content data, the part may be set to a predetermined length from the particular position of the content data.

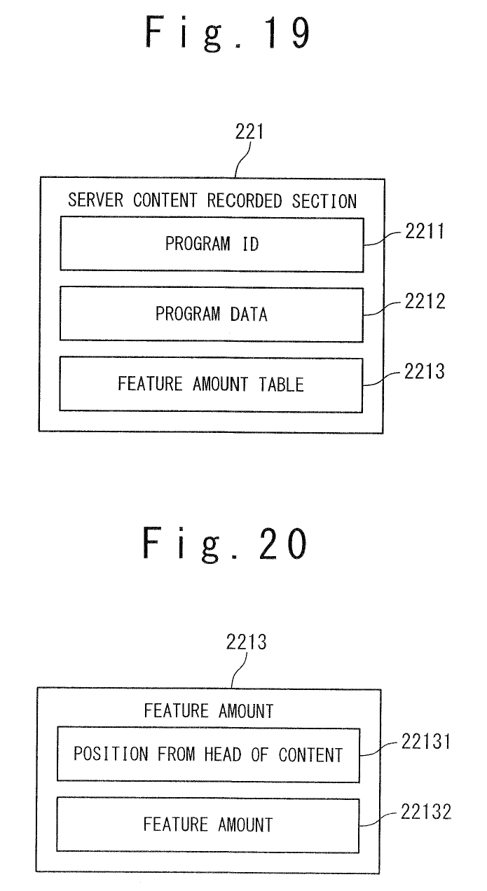

As shown in FIG. 19, the server content recorded section 221 in the fifth exemplary embodiment is composed of a program identifier 2211, a program content data 2212 and a feature amount table 2213. Also, as shown in FIG. 20, the feature amount table 2213 is composed of a data indicating [Position from Head of Content (Number of Bytes)] 22131 and a data indicating a feature amount 22132. When the content indication data is MPEG (Moving Picture Expert Group), an interval to calculate the feature amount may be considered to be executed in a GOP unit.

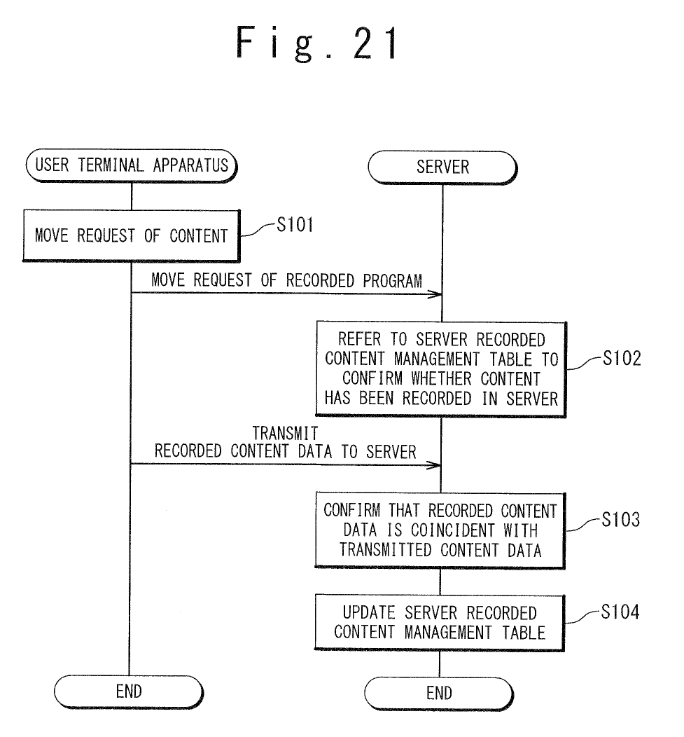

At first, with reference to FIG. 21, the upload of the perfectly same content data will be described in detail. The user terminal apparatus 1 performs a move request of the content data on the server 2 (Step S101). At this time, the user terminal apparatus transmits the content indication data as the move request to the server 2. The server 2 receives the move request and compares the program name 22221, the broadcast station 22222, the broadcast time 22223 and the feature amount 22224 in the content indication data 2222 on the server recorded content management table 222 with the transmitted content indication data. In the fifth exemplary embodiment, since the content indication data includes the feature amount, the feature amount is also compared. Consequently, whether or not the same content indication data as the content indication data to be moved is recorded in the server content recorded section 221 is checked (S102). If the same content indication data is located on the server, the server 2 checks that the content data recorded in the server content recorded section 221 and the content data transmitted from the user terminal apparatus are same (S103). The server 2 does not newly record the content data in the server content recorded section, if the content data having been recorded in the server content recorded section 221 and the content data transmitted from the user terminal apparatus are same. When confirming that the content data are same, the server updates the server recorded content management table 222 in order to record that the user terminal apparatus executing the move request has recorded the content data (S104). The confirmation (S103) of the fact that the content data are same may be executed after the transfer of the whole content data is completed or may be sequentially executed in the course of the transfer of the content data.

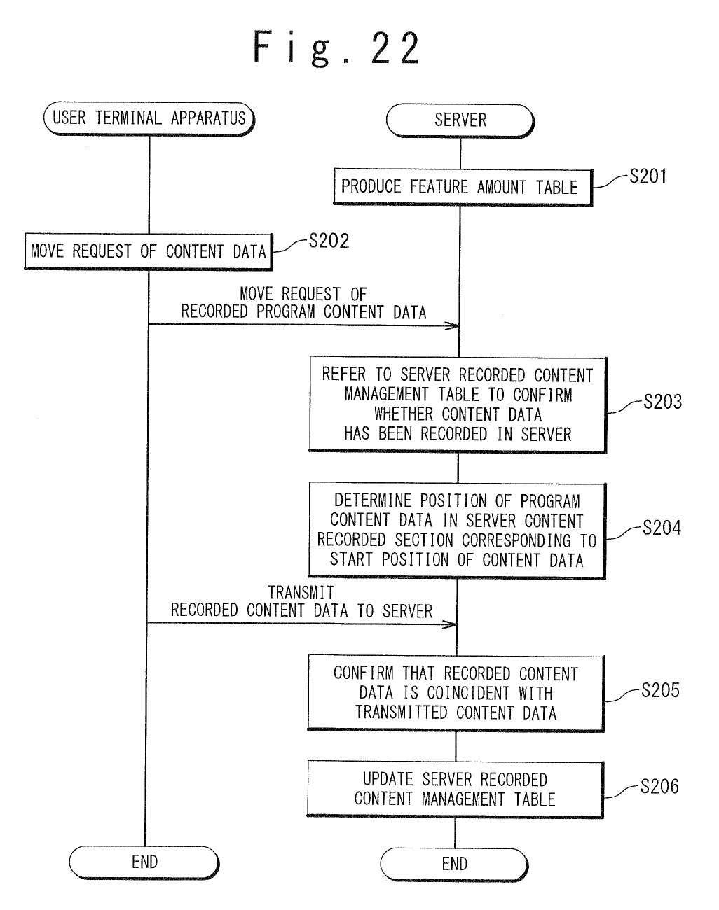

The upload of the content data having a different record time will be described below in detail with reference to FIG. 22. It is supposed that after a user starts the recording from a head point of the program and then uploads the content data, another user starts the recording from a middle point of the program and then tries to upload the content data. The server 2 records the feature amount of the content data stored in the server content recorded section in the feature amount table 2213 at a particular time interval (S201). Specifically, the feature amount is calculated in the GOP (Group of Picture) units. The user terminal apparatus 1 issues the move request of the content data to the server 2 (S202). At this time, the user terminal apparatus transmits the content data as the move request to the server 2. The server 2 receives the move request and refers to the program name 22221, the broadcast station 22222, the broadcast time 22223 and the feature amount 22224 in the content indication data 2222 on the server recorded content management table 222. The server 2 compares the transmitted content data with the content indication data 2222 on the server recorded content management table 222 and consequently checks whether or not the same content data as the content data to be moved has been recorded in the server content recorded section 221 (S203).

At this time, the content data to be moved has been recorded from the middle of the program. Thus, the content data in the server content recorded section 221 and the content data transmitted from the user terminal apparatus are not coincident in their broadcast times. The server 2 refers to the feature amount table 2213 to compare the feature amount 22132 on the feature amount table 2213 and the feature amount transmitted from the user terminal apparatus 1. Consequently, a portion in the content data recorded in the server content recorded section corresponding to the content data that is tried to be transmitted from the user terminal apparatus 1 is determined (S204). Moreover, it is confirmed through comparison in a binary unit that the transmitted content data is a part of the content data on the server.

If the content data tried to be transmitted from the user terminal apparatus 1 is confirmed to be the part of the content data recorded in the server content recorded section (S205), the content data is not newly recorded in the server content recorded section. At the same time, the server recorded content management table is updated to indicate that the user terminal apparatus has been recorded the content data, (S206). At this time, the portion of the entire program content data at which the content data recorded by the user terminal apparatus is located, i.e., the start position and end position from the head position are recorded. It should be noted that the checking whether or not the content data are same (S205) may be executed after the transfer of the entire content data is completed or may be sequentially executed in the course of the transfer of the content data.

As mentioned above, according to the content accumulating system based on the present invention, the record state and erasure state of the program content data in the user terminal apparatuses 1-1 to 1-n can be collectively managed by the server 2 connected through the network 3. The content data recorded previously by the user terminal apparatus 1 can be acquired again in the quality when it was recorded by the user terminal apparatus 1 even after erasure.

According to the content accumulating system of the present invention, the server 2 collectively recognizes the record states of the program content data in the user terminal apparatuses 1-1 to 1-n. Thus, the program content data can be distributed to the user terminal apparatuses 1 without copy. For this reason, the program content data of the same program is not required to be recorded by the plurality of user terminal apparatuses 1. Moreover, since the server 2 collectively manages the record states of the program content data, the storage capacity of the server can be efficiently used.

As mentioned above, although the exemplary embodiments of the present invention have been described in detail, a specific configuration is not limited to the above-mentioned exemplary embodiments. Even modifications in the range without departing from the scope and spirit of the present invention are included in the present invention. The server 2 in the first exemplary embodiment records all of the programs broadcasted from the broadcast stations 4-1 to 4-n. However, the user terminal apparatus 1 may acquire the reservation data used in the record reservation and record only the program content data corresponding to the reservation data. In this case, the user terminal apparatus 1 transmits to the server, the content data including the program name and the broadcast time as the reservation data, and the quality data of the data to be recorded. When receiving the reservation data of the same program from the user terminal apparatuses 1-1 to 1-n, the server 2 records the program content data in the highest quality data included in the reservation data, and converts the recorded program content data into the quality when each user terminal apparatus 1 records it, in response to the distribution request from the user terminal apparatuses 1-1 to 1-n, and then distributes the converted program content data.

Also, in this exemplary embodiment, the user terminal apparatus 1 has been described, taking the record reproducing apparatus for recording the broadcasted program as one example. However, it may be a personal computer, PDA or a mobile phone for recording the content data, such as image and music data, which is distributed through the network 3 such as the Internet. Moreover, the user terminal apparatus 1 in this exemplary embodiment records the content data, which is distributed from the server 2, in the user content recorded section 121. However, the content data stream distributed from the server may be outputted (displayed) without being recorded in the user content recorded section 121.

1-21. (canceled)

22. A content accumulating system comprising:
at least one user terminal apparatus; and
a server connected to said user terminal apparatus,
wherein said user terminal apparatus comprises:
a user content recorded section in which a content data transmitted from an external apparatus is recorded;
a user record data notifying section configured to notify to said sever that the content data has been recorded; and
a content requesting section configured to issue to said server, a distribution request of the content data which has been recorded in said user content recorded section, and
wherein said server comprises:
a recorded data confirming section configured to confirm whether or not the content data has been recorded by said user terminal apparatus based on the notice from said user terminal apparatus in response to the distribution request; and
a content distributing section configured to transmit the content data, which is confirmed to have been recorded, to said user terminal apparatus.

23. The content accumulating system according to claim 22, wherein said user record data notifying section transmits to said server, a content data to identify the content data, which has been recorded in said user content recorded section,
said server comprises:
a server recorded content management table used to manage a record state of the content data in the user terminal apparatus; and
a user recorded content managing section configured to record the record state of the content data in said user terminal apparatus as a recorded state in said server recorded content management table, and
said recorded data confirming section refers to said server recorded content management table to confirm whether or not the content data has been recorded in the user terminal apparatus, in response to the distribution request.

24. The content accumulating system according to claim 22, wherein when confirming that said content data has recorded in said user terminal apparatus, said recorded data confirming section issues a distribution request to another user terminal apparatus which has said contents data, and
said another user terminal apparatus transmits said content data to the user terminal apparatus as a distribution request source in response to said distribution request.

25. The content accumulating system according to claim 22, wherein said user record data notifying section transmits to said server, a content data to identify the content data and the content data to be erased, before erasing the content data which has been recorded in said ser content recorded section,
said server further comprises a server content record section in which the content data is recorded,
a content request section of said user terminal apparatus issues a distribution request of the erased content data to said server,
a recorded data confirming section of said server checks that the content data corresponding to said content data has recorded in said user terminal apparatus based on said content data, and
a content distributing section extracts the content data confirmed to have recorded in said user terminal apparatus from said server content record section in response to said distribution request and transmits to said user terminal apparatus as the issuing source of said distribution request.

26. The content accumulating system according to claim 22, wherein said server further comprises a server content record section in which the content data transmitted from an external unit is recorded, and
said content distributing section extracts the content data confirmed to have recorded in said user terminal apparatus from said server content record section in response to said distribution request and transmits to said user terminal apparatus as an issuing source of said distribution request.

27. The content accumulating system according to claim 22, wherein said user record data notifying section transmits a reservation data to record the content data in said ser content recorded section to said server,
said server further comprises a server content record section in which the content data transmitted from the external unit is recorded based on said reservation data, and
said content distributing section extracts the content data confirmed to have recorded in said user terminal apparatus from said server content record section in response to said distribution request and transmits to said user terminal apparatus as an issuing source of said distribution request.

28. The content accumulating system according to claim 23, wherein said content data is a program content data broadcast from a broadcasting station, and
said content data is a data which identifies a broadcast program and contains a data to identify a use channel and a broadcasting time.

29. The content accumulating system according to claim 22, wherein said user record data notifying section of said user terminal apparatus transmits a quality data indicating a quality of the content data recorded in said ser content recorded section to said server in response to said notice,
said recorded data confirming section confirms whether or not the content data requested to be distributed is recorded in said user terminal apparatus based on said notice, and
said content distributing section transmits the content data confirmed to have been recorded to said user terminal apparatus in a quality equal to or lower than the quality.

30. The content accumulating system according to claim 22, wherein a content request section of said user terminal apparatus issues a distribution request of the content data which has been erased from said ser content recorded section to said server,
a content distributing section of said server confirms whether or not the content data required to be distributed has recorded in said user terminal apparatus based on said notice, and
said content distributing section transmits the content data confirmed to have been recorded to said user terminal apparatus.

31. The content accumulating system according to claim 23, wherein the content indication data has a feature amount obtained through a predetermined calculation to the program content data,
said user record data notifying section transmits the content indication data to said server and transmits the program content data recorded in said ser content recorded section,
said server comprises a server content record section in which the content indication data transmitted from the user terminal apparatus and the content data are recorded,
when the content indication data and the content data are transmitted from a user terminal apparatus, said server compares the feature amount of the content data recorded in said server content record section and the feature amount of the content data transmitted from said user terminal apparatus, and does not record the content data transmitted from said user terminal apparatus in said server content record section, when these content data is determined to be coincident with each other, and
said content distributing section distributes the content data recorded in said server content record section when the distribution of the content data should be carried out when there is a distribution request of the content data from the user terminal apparatus.

32. The content accumulating system according to claim 31, wherein said server compares the feature amount of the content data recorded in said server content record section and the feature amount of the content data transmitted from said user terminal apparatus, and notifies that it is not necessary to transmit the content data to said user terminal apparatus, when these content data are determined to be coincident with each other.

33. A user terminal apparatus comprising:
a user content recorded section in which a content data transmitted from an external apparatus is recorded;
a user record data notifying section configured to notify to said sever that the content data has been recorded; and
a content requesting section configured to issue to said server, a distribution request of the content data which has been recorded in said user content recorded section.

34. A content accumulating method in a user terminal apparatus connected to a server, comprising:
recording a content data transmitted from an external unit in a user content recorded section of said user terminal apparatus;
notifying that said content data has recorded in said ser content recorded section, to said server;
issuing a distribution request of the content data having been recorded in said ser content recorded section to said server;
acquiring said content data confirmed to have been recorded by said server based on said notice and distributed in response to said distribution request.

35. The content accumulating method according to claim 34, wherein said notifying comprises:
transmitting a content indication data to said server to identify the content data recorded in said ser content recorded section.

36. The content accumulating method according to claim 34, further comprising:
extracting the content data having been recorded in said ser content recorded section in response to a transmission request of the content data which is issued from said server which received a distribution request from another user terminal apparatus; and
transmitting the extracted content data to said another user terminal apparatus as a request source of said distribution request.

37. The content accumulating method according to claim 34, further comprising:
transmitting the content data to be erased and the content indication data to identify the content data to be erased to said server, before erasing the content data having been recorded in said ser content recorded section;
issuing the distribution request of the content data having been erased to said server; and
distributing said content data from said server after confirming that said content data has been erased, in response to said distribution request.

38. The content accumulating method according to claim 34, further comprising:
issuing the distribution request of the content data having been erased to said server is carried out after said recorded content data is erased from said ser content recorded section.

39. The content accumulating method according to claim 35, wherein said content indication data has a feature amount obtained through a predetermined calculation to the content data, and
said content accumulating method further comprises:
transmitting a first content indication data and a first content data having been recorded in a ser content recorded section from a first user terminal apparatus to said server;
recording said first content indication data and said first content data in a server content record section;
transmitting a second content indication data and a second content data from a second user terminal apparatus to said server;
comparing the feature amount of said first content data having been recorded in said server content record section and the feature amount of said second content data transmitted from said second user terminal apparatus;
performing no recording operation of the content data transmitted from said second user terminal apparatus in said server content record section when these content data are determined to be coincident with each other; and
distributing the content data having been recorded in said server content record section when said server performs distribution of the content data in response to the distribution request of the content data from a user terminal apparatus.

40. The content accumulating method according to claim 39, further comprising:
when the feature amount of the content data has been recorded in said server content record section and the feature amount of the second content data transmitted from said second user terminal apparatus are compared and it is determined that these content data are determined to be coincident with each other, notifying to said second user terminal apparatus that it is not necessary to transmit said second content data.

41. A computer-readable software product in which a content accumulation program is written to make a computer to execute a content accumulating method in a user terminal apparatus connected to a server, wherein said content accumulation program comprises:
recording a content data transmitted from an external unit in a ser content recorded section;
notifying that said content data has recorded in said ser content recorded section, to said server;
issuing a distribution request of the content data having been recorded in said ser content recorded section to said server; and
acquiring said content data confirmed to have been recorded in said user terminal apparatus by said server based on said notice and distributed in response to said distribution request.
